(19) United States
(12) Patent Application Publication
(10) Pub. No.: US 2024/0344216 A1
(43) Pub. Date: Oct. 17, 2024

(54) THIN FILM POROUS CATALYST SHEET

(71) Applicant: NEDERLANDSE ORGANISATIE VOOR TOEGEPAST-NATUURWETENSCHAPPELIJK ONDERZOEK TNO, 's-Gravenhage (NL)

(72) Inventor: Alireza Pezhman SHIRVANIAN, Heerhugowaard (NL)

(21) Appl. No.: 18/577,811

(22) PCT Filed: Jul. 12, 2022
(86) PCT No.: PCT/NL2022/050406

§ 371 Date: Jan. 9, 2024

(30) Foreign Application Priority Data
Jul. 12, 2021 (NL) 2028705

(51) Int. Cl. C25B 11/031; C25B 1/04; C25B 9/23; C25B 9/75

(52) U.S. Cl. CPC C25B 11/031; C25B 1/04; C25B 9/23; C25B 9/75

(57) ABSTRACT

The disclosure pertains to catalyst sheet, in particular for a Proton Exchange Membrane Water Electrolyzer or Anion Exchange Membrane Water Electrolyzer, comprising a substrate sheet and a deposited catalyst material, wherein the substrate sheet is porous and electrically conductive; and to an electrolyzer comprising such a catalyst sheet, a hydrogen production method, and a manufacturing method.

### FIELD

The invention pertains to catalyst sheets comprising a substrate sheet and a catalyst material, in particular for e.g. Proton Exchange Membrane Water Electrolyzers and/or Anion Exchange Membrane Water Electrolyzers.

### INTRODUCTION

Ion-exchange membrane reactors are widely used in electrochemical reactions. For instance, generation of hydrogen by means of water splitting in Proton Exchange Membrane Water Electrolyzers or Anion Exchange Membrane Water Electrolyzers has received attention as a promising technique for chemically storing electrical energy.

In ion-exchange membrane reactors, there is typically a catalyst layer (CL) placed between the conducting ion-exchange membrane and a porous transport layer (PTL). Such a catalyst layer and a porous transport layer can be present on the anode side of the ion-exchange membrane reactor, on the cathode side of the ion-exchange membrane reactor, or both.

Known catalyst layers are often provided as a coating on a membrane, giving a catalyst coated membrane, typically by depositing a catalyst ink on a ion-conducting membrane. The catalyst ink comprises catalyst nanoparticles mixed with binder. The binder is for instance an ionomer.

Accordingly, such catalyst layers comprise catalyst nanoparticles, which are in electrical contact with each other and the porous transport layer (PTL) and in ionic-contact with the membrane. In order to stabilize and/or hold the nanoparticles in place an ionomer can be used, which functions both as a binder and as ionic conductor within the catalyst layer, thereby maintaining electrical contact between the different nanoparticles and between the nanoparticles and the porous transport layer, as well as ionic contact between the nanoparticles and the membrane. Perfluorosulfonic Acid (PFSA)-based ionomers, for instance Nafion™, are typically used as ionomer.

However, these ionomers (e.g. Nafion™) used as ion conductor and binder, can cover or partially cover the catalyst nanoparticles, thereby reducing the accessible catalyst surface. In addition, the ionomer and/or binder can decrease porosity of porous catalyst layers, which can have a negative effect on mass transfer of both reactants and products. This problem can happen both on the anode and on the cathode side catalyst layer.

Another problem is that at low catalyst loadings, isolated agglomerates of catalyst nanoparticles can be formed, which are not in contact with either the rest of the catalyst nanoparticles of the catalyst layer or with the porous transport layer, which can lead to a decrease in catalyst utilization.

In addition, with the existing porous catalyst layers, it is also challenging, especially when the reactor is operated at high current densities, that gas bubbles that may be formed as products often deprive the catalyst surface of reactant. The porosity of existing porous catalyst layers is not suited to facilitate quick removal of gas bubbles from the catalyst surface.

A shortcoming of the conventional catalyst layer is that upon degradation of ionomer or binder, some catalyst nanoparticles can be physically dislodged or detached from the rest, thus leading to a loss in performance of the reactor.

Another downside of the existing catalyst layers is that the catalyst nanoparticles are not stable for extended periods. Due to factors such as agglomeration and dissolution as well as Ostwald ripening of some of the catalyst material, the porous catalyst layer tends to deactivate relatively quickly over time.

Furthermore, because precious metals are often used as catalyst material in ion-exchange membrane reactor, the costs of such reactors can be very high. Therefore, it is not only important to solve problems such as low catalyst utilization and other inefficiencies from a technical viewpoint, but also from an economic viewpoint. Especially for applications such as hydrogen generation by water splitting, which has the potential to become a very important way for storage of electrical energy e.g. in the form of chemical bonds, improvement of the efficiency and reduction of costs of ion-exchange reactors can have a very large impact, both technically and economically.

In order for Proton Exchange Membrane Water Electrolyzers to become an economically viable technology for producing hydrogen, it is desired to provide electrolyzers that can be operated at high current densities, using low catalyst loadings.

Shirvanian, Novel components in Proton Exchange Membrane (PEM) Water Electrolyzers (PEMWE): Status, challenges and future needs. A mini review, Electrochemistry Communications, 114, 2020, 106704, provides a review of Proton Exchange Membrane (PEM) Water Electrolyzers.

Bühler et al, From Catalyst Coated Membranes to Porous Transport Electrode Based Configurations in PEM Water Electrolyzers, J. Electrochem. Soc. 166 F1070 (2019) describes porous transport electrodes for membrane electrode assemblies. IrO₂ ink was used for spray coating the anodic catalyst layers; the ink contained 2 wt. % Nafion on dry basis and was applied on sintered titanium fiber substrate.

It is an object of the invention to provide a catalyst layer which solves one or more of the above-mentioned challenges with known catalyst layers. Furthermore, it is an object of the invention to provide a catalyst layer with improved properties for ion-exchange membrane reactors, for instance relating to porosity, mass-transport, conductivity, available catalyst surface area, catalyst utilization.

### SUMMARY

The invention pertains in a first aspect to a catalyst sheet, in particular for a Proton Exchange Membrane Water Electrolyzer or Anion Exchange Membrane Water Electrolyzer, comprising a substrate sheet and a deposited catalyst material, wherein the substrate sheet is porous and electrically conductive, and wherein the catalyst material is deposited as a thin film or as thin film patches on the internal and/or external surface of said substrate sheet. Preferably the majority of the deposited catalyst material, preferably 60 wt. % or more, of the deposited catalyst material, is deposited on the internal surface of the substrate at a pore depth of 50 μm or less. Preferably, the catalyst sheet is preferably self-supporting.

The invention also pertains to a membrane electrode assembly for an electrochemical reactor comprising an ion-exchange membrane and an adjacent catalyst layer, wherein the catalyst layer is provided as a catalyst sheet according to the invention; preferably further comprising a porous transport layer.

The invention also pertains to an ion exchange membrane water electrolyzer, in particular a Proton Exchange Membrane Water Electrolyzer or Anion Exchange Membrane Water Electrolyzer, comprising an anode, a cathode, a proton-exchange membrane or an anion-exchange membrane, on each side of said proton-exchange membrane or anion-exchange membrane a catalyst layer and a porous transport layer and typically a bipolar plate, wherein at least one of the catalyst layers is provided as a catalyst sheet according the invention.

The invention also pertains to a hydrogen production method carried out in the inventive Proton Exchange Membrane Water Electrolyzer or Anion Exchange Membrane Water Electrolyzer, the method comprising providing water to the catalyst layer on each side of the proton-exchange membrane and applying a voltage between the anode and the cathode.

The invention also pertains to a method of manufacturing a catalyst sheet according to the invention, the method comprising: producing and/or providing a porous and electrically conductive substrate sheet; and depositing a thin film or thin film patches of catalyst material on the internal and/or external surface of said substrate sheet.

### BRIEF DESCRIPTION OF THE DRAWINGS

FIG. 1 schematically illustrates a catalyst sheet according to the invention, placed between an ion-exchange membrane and a porous transport layer.

FIG. 2 schematically illustrates a catalyst sheet according to the invention which comprises a porous transport layer.

FIG. 3 schematically illustrates a membrane electrode assembly according to an illustrative embodiment of the invention.

FIG. 4 shows an electron microscopy image of the substrate sheet used in one of the examples.

FIG. 5 shows a photograph of a catalyst sheet prepared in one of the examples.

FIG. 6 shows the results of an accelerated stress test of 2000 cycles of increasing and decreasing potential.

FIG. 7 shows a plot of the specific power density at different current densities.

FIG. 8 shows a polarization curve.

FIG. 9 shows a cross-sectional SEM image of a catalyst sheet.

Any embodiments illustrated in the figures are examples only and do not limit the invention.

### DETAILED DESCRIPTION

The present invention is in an aspect based on the judicious insight of using a catalyst sheet comprising a porous electrically conductive sheet as substrate sheet and depositing the catalytically active material as thin film or thin film patches on the internal and/or external surface of the support.

As used herein, and as is common in the art, the external surface of the porous substrate sheet refers to the surface of the substrate sheet that is accessible for matter that has a shortest dimension that is too large to fit in the largest pore of the substrate sheet. The internal surface refers to the surface of the porous substrate sheet that is only accessible by matter (such as objects or gases) that are small enough to fit in the pores of the porous substrate sheet.

Thereby the advantage is provided of improved use of the electrochemically active surface area (ECA) of the catalyst material. Furthermore, increased stability of the catalyst can be obtained.

Because electrolysis of water, as well as other electrochemical processes require the use of expensive catalysts, containing precious metals, it is very important that the catalyst material for such processes is efficiently used. How efficiently a certain catalyst material is used can be described by various different parameters. One of these parameters is catalyst loading. Catalyst loading in membrane reactors is typically expressed in terms of catalyst weight relative to the geometric surface area of the membrane. If catalyst loading in an electrochemical cell can be made lower without negatively affecting the performance of the electrochemical reactor, the catalyst material is used more efficiently. Another parameter that can be used to describe if the catalyst material is efficiently used is catalyst utilization.

As used herein, catalyst utilization refers to the amount of surface area of the catalyst material that is available for performing catalysis, relative to the total surface area of the catalyst material. Factors that can influence catalyst utilization include the amount of catalyst surface that is exposed and is accessible by the reactants, but also mass transfer, i.e., how fast reactants can reach the catalyst surface and how fast products leave the catalyst surface after being formed. Another factor that contributes to efficient use of catalyst material is catalyst performance. Catalyst performance, also known as turnover frequency, refers to the amount of reactant that a can be converted into product per unit time by an active site of catalyst material. Many factors play a role in catalyst performance, such as the chemical nature of the reactants, products and catalyst material, surface of the catalyst material, reaction mechanism, reaction conditions such as temperature and pressure, etc.

In order to make efficient use of scarce and expensive catalyst materials, such as precious metals, in electrochemical reactors, it is desired to reduce catalyst loading without affecting the performance of the electrochemical reactor too much, or ideally even improving the performance of the reactor despite reduction of catalyst loading.

In electrochemical cells, it is important that the catalyst is in electrical contact with the electrode. In case the catalyst comprises multiple individual catalyst pieces, it is important that these individual catalyst pieces are in electrical contact with each other and with the electrode.

In the present invention, by providing a catalyst sheet in which catalyst material is deposited as a thin film or as thin film patches on the internal and/or external surface of an electrically conductive substrate sheet, all the catalyst material that is deposited on the support will be in electrical contact with each other and, when the substrate sheet is in electrical contact with the electrode, with the electrode. This provides an advantage to electrochemical cells known in the art, wherein the catalyst material is often provided as nanoparticles, and electrical contact between individual catalyst nanoparticles is provided through direct physical contact of particles which are held in place by a binder and/or ionomer. Such systems are much more difficult to control than catalyst deposited on an electrically conductive substrate sheet. For instance, it can occur that a some of the nanoparticles are isolated from the rest of the nanoparticles and are not in electrical contact with the electrode, especially at lower catalyst loadings. If such isolation occurs, this has a negative effect on catalyst utilization.

Efficient mass transfer, i.e., transfer of fluids towards and away from the catalyst surface is very important in order to effectively utilize the available catalyst material. The properties of the porous substrate sheet can be chosen such that good mass transfer can be achieved. Parameters that can be optimized include void fraction & (sometime also called porosity), tortuosity t, and the pore sizes of the pores of the porous substrate sheet.

Preferably, the catalyst sheet is self-supporting. Known catalyst layers in ion-exchange membrane reactors are often applied as a catalyst coating on the membrane. Such catalyst coated membranes are typically produced by depositing a catalyst ink comprising catalyst material and a binder or an ionically conductive ionomer onto the membrane. By providing a self-supporting substrate sheet with a thin film or thin film patches deposited thereon, it may become easier to assemble membrane electrode assemblies and/or to replace the catalyst sheet in an existing membrane reactor. It also allows production of the catalyst sheet to be performed in a different location or by a different party than assembly of membrane electrode assemblies.

Providing a substrate sheet onto which a thin film or thin film patches of catalyst material are deposited may also lead to catalyst sheets that are more reproducible and consistent in quality than membranes with a catalyst material printed thereon.

Also provided herein is a membrane electrode assembly for an electrochemical reactor comprising an ion-exchange membrane and an adjacent catalyst layer, wherein the catalyst layer is provided as a catalyst sheet as described herein.

In a membrane electrode assembly and/or in an ion-exchange membrane reactor, such as a Proton Exchange Membrane Water Electrolyzer or an Anion Exchange Membrane Water Electrolyzer, the catalyst sheet is preferably placed directly adjacent to the ion-exchange membrane. In embodiments, the catalyst sheet has a membrane side and an opposite side. If the catalyst sheet has a membrane side, this membrane side should preferably face the membrane when the catalyst is placed in a membrane electrode assembly or in an electrochemical reactor.

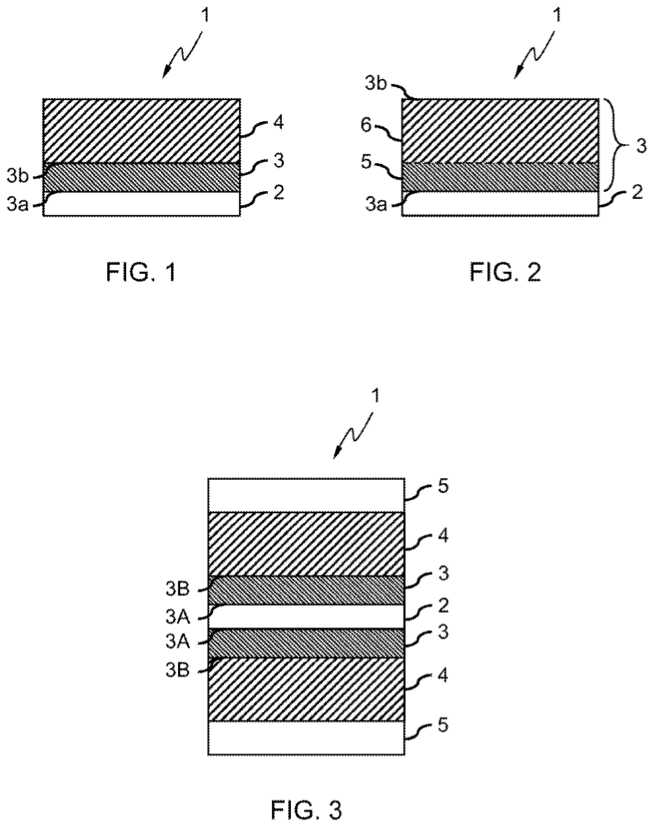

FIG. 1 shows a schematic overview of a membrane electrode assembly according to example embodiments of the invention, in which membrane electrode assembly (1) comprises an ion-exchange membrane (2), a catalyst sheet (3), and a porous transport layer (4). Catalyst sheet (3) has membrane side (3a) and opposite side (3b).

In membrane electrode assemblies that are used in ion-exchange membrane reactors, a catalyst sheet according to the invention may be placed on one side or on both sides of the ion-exchange membrane. In an electrochemical reactor, the membrane typically has an anode side and a cathode side. A catalyst sheet according to the invention may be placed on the anode side of the ion-exchange membrane, on the cathode side of the membrane, or on both sides of the membrane. If catalyst sheets according to the invention are placed on both the anode side and the cathode side of an ion-exchange membrane, the catalyst material will typically be different for the two catalyst sheets, because the reaction that needs to be catalyzed on the anode side will typically be different from the reaction that needs to be catalyzed on the cathode side. This is further illustrated in FIG. 3 hereinafter. Particularly preferred is that the catalyst sheet is placed at the anode side, even more in particular with metal cloth substrate and Ir catalyst.

Preferably the substrate sheet is self-supporting. This means in particular that the sheet can be handled as an individual sheet.

Because the substrate sheet should be electrically conductive, the substrate preferably comprises a metal. Especially suitable materials for the substrate sheet include one or more selected from Ti, Zr, Hf, V, Nb, Ta, W, Cr, V, Mo, as well as oxides, carbides, nitrides, borides, and combinations thereof. Because of its low density and low cost relative to the other suitable metals, the substrate sheet preferably comprises Ti. These materials and preferences apply especially for catalysts used at the anode side.

Suitable porous substrate sheets can for instance comprise fibers of metal (such as Ti) in particular, woven together and sintered to stabilize the fibers. An example of such a substrate is used in Example 1. In other cases, the substrate sheet comprises micron sized particles of a metal (such as Ti), sintered together to form a porous sheet.

In a preferred embodiment, the substrate sheet consists of metal fiber cloth, for instance cloth made of fibers of one or more metals selected from the group of Ti, Zr, Hf, V, Nb, Ta, W, Cr, Mo, and V, as well as oxides, carbides, nitrides, borides, and combinations thereof; more preferably cloth made of fibers of one or more metals selected from the group of Ti, Zr, Hf, V, Nb, Ta, W, Cr, Mo, and V. Very preferably the substrate sheet consists of Ti fiber cloth.

Preferably, the fiber of the cloth, in particular metal fiber, has a diameter in the range of 5-100 μm, more preferably 10-50 μm, preferably with said metal fibers. For example, the fiber cloth has a void fraction in the range of 10-80%, e.g. 40-70% by volume. The void fraction can for instance be measured using electron microscopy, such as Scanning Electron Microscopy (SEM).

Cloths of other conducting materials, notably carbon, may be used e.g. when the catalyst sheet is used in a fuel cell, but carbon cloths are less preferred for use in water electrolyzers, because carbon degrades quickly at the higher voltages that are used in water electrolyzers compared to the lower voltages used in fuel cells.

Especially suitable porous substrate sheets are Bekipor® materials that can be obtained from the company Bekaert or WEBTi® materials obtained from the company Toho Titanium. For instance, using Bekipor® ST 2 GDL 10-0.25 as substrate sheet, which is a cloth made of Ti fibers with a diameter of ca. 22 μm⋅a porosity of 56%, and a weight of 500 g/m², excellent results were obtained as illustrated in the Examples.

Depending on the reaction that needs to be catalyzed, a wide variety of catalyst materials can be deposited. In the invention, the catalyst material is deposited as a thin film or as thin film patches onto the internal and/or external surface of the porous substrate sheet, as opposed to deposition of catalyst nanoparticles.

The catalyst material may comprise one or more metals and/or metal oxides. Preferably, the catalyst material comprises one or more transition metals (i.e., Group 3-Group 12 metals) and/or oxides thereof.

In preferred embodiments in which the catalyst sheet is used for electrochemical production of hydrogen at the anode side during electrolysis of water, the catalyst material preferably comprises one or more selected from the group of Ru, Rh, Pd, Os, Ir, Pt and oxides thereof.

Particularly good results for electrolysis of water have been obtained when the catalyst comprises Ir and/or Iridium oxide; for catalysts sheets used at the anode side.

In electrocatalysis, the catalyst material is conventionally often in the form of nanoparticles in known processes and apparatuses. Because of the high surface-to-volume ratio of nanoparticles, for instance spherical or spheroid nanoparticles, it is often believed that it is good to provide catalyst material in the form of nanoparticles. It was found that very advantageously, improved stability of the catalyst can be obtained by providing the catalytically active material as thin film or thin film patches on a substrate sheet. Without wishing to be bound by way of theory, catalyst material in this form may be less susceptible to processes such as dissolving, sintering, agglomeration, coalescence and Ostwald ripening compared to nanoparticles which typically contain regions where the surface of the nanoparticle is extremely curved leading to high surface energy.

Contrarily to nanoparticles, the thin film or thin film patches may each have a length direction and a width direction, which extend along the surface of the substrate sheet and are perpendicular to each other, and a thickness direction perpendicular to both the length and width direction, wherein the length and width of the thin film or thin film patches are independently of each other at least 2 times higher than the thickness of the thin film or thin film patches, preferably at least 5 times higher. Accordingly, the thin film or thin film patches have an aspect ratio of at least 2, more preferably at least 5.

Preferably, the mean thickness of the thin film and/or thin film patches is 10 nm or less, such as 5 nm or less. More preferably, the thin film or thin film patches preferably each have a thickness of 5 nm or less, even more preferably 2 nm or less. This contributes to efficient catalyst use.

The dimensions in the length and width direction, as well as the thickness of the thin film or the thin film patches can be measured using different methods. For instance, on flat surfaces, these dimensions and thickness can be characterized using ellipsometry. Other suitable methods for characterizing the dimensions and thickness of the thin film or thin film patches include High Resolution Scanning Electrode Microscopy (HR-SEM) and Transmission Electron Microscopy (TEM). Electron microscopy techniques are especially suitable for characterizing the thin film patches when they are deposited on surfaces that are not flat, such as on the internal surface area of the substrate sheet.

As used herein, pore depth refers to a position in a pore of the catalyst sheet at a certain distance from the membrane side of the catalyst sheet, wherein said distance is measured along the direction orthogonal to the plane of the membrane side of the catalyst sheet. If the thin film or thin film patches of catalyst material are deposited at the external surface of the catalyst sheet on the membrane side, direct contact of the catalyst material with the membrane can block the active sites on the catalyst surface, thus leading to poor catalyst utilization. Therefore, it is preferred to have the catalyst deposited very close to the external surface of the catalyst sheet on the membrane side but to minimize the amount of catalyst on the external surface in direct contact with the membrane.

Therefore, the majority of the catalyst material, e.g. at least 60 wt. % of the catalyst material, is preferably deposited on the internal surface of the substrate sheet, at a pore depth >0.10 μm.

On the other hand, when the catalyst material is deposited at too high pore depths, i.e., too far away from the ion-exchange membrane, this might also negatively influence the performance of an electrochemical reactor. The negative influence on performance is caused by the fact that proton transport (or, in case of an anion exchange membrane, anion transport) from catalyst material to the membrane becomes increasingly difficult when the catalyst material is further away from the membrane. Therefore, in embodiments, the majority of the catalyst material, e.g. at least 60 wt. % of the catalyst material is deposited at a pore depth of 50 μm or less, preferably 30 μm or less, more preferably 20 μm or less, even more preferably 10 μm or less, such as 5 μm or less. In preferred embodiments, 80 wt. % or more, preferably 90 wt. % or more, of the total amount of catalyst material is deposited on the internal surface of the substrate sheet at a pore depth of 20 μm or less. Even more preferably, 80 wt. % or more of the total amount of catalyst material, preferably 90 wt. % or more, more preferably 95 wt. % or more, is deposited on the internal surface of the substrate sheet at a pore depth of 0.10-20 μm.

In membrane electrode assemblies known in the art that are used in ion-exchange membrane reactors, catalyst layers are typically applied on the membrane as a catalyst ink. On the opposite side of the catalyst layer, there is typically a porous transport layer which serves to transport reactants towards, and products away from the catalyst layer. Catalyst sheets according to the invention can also be placed between a membrane and a porous transport layer in the same way as in the ion-exchange membrane reactors known in the art, as is schematically shown in FIG. 1.

Accordingly, the invention also pertains to a stacked assembly of an ion exchange membrane, a catalyst sheet as provided in the present disclosure, and a porous transport layer, wherein the ion exchange membrane, catalyst sheet, and porous transport layer are stacked in this order.

Alternatively or additionally, the catalyst sheet according to the invention may also comprise a porous transport layer. In case the catalyst sheet according to the invention also comprises a porous transport layer, the catalyst sheet comprises a catalyst layer and a porous transport layer.

FIG. 2 shows a schematic overview of a membrane electrode assembly (1), comprising an ion-exchange membrane (2) and a catalyst sheet (3). The catalyst sheet comprises a catalyst layer (5) and a porous transport layer (6).

The thickness of the catalyst sheet is for example in the range of 2-50 μm, preferably 5-30 μm, such as 10-20 μm. In case the catalyst sheet comprises a porous transport layer, the thickness of the catalyst sheet is for example in the range 50 μm-1 mm, preferably 100-500 μm, such as 150-250 μm.

An example of a catalyst sheet comprising a catalyst layer and a porous transport layer is the catalyst sheet as described above, onto which the majority of the catalyst material is deposited at a pore depth of 50 μm or less. In that case, the layer of the catalyst sheet in which the majority of the catalyst material is deposited is called the catalyst layer, whereas the rest of the catalyst sheet is referred to as the porous transport layer.

In case the catalyst sheet is thin, for instance 50 μm or less, it might be advantageous to stack it on top of another substrate sheet onto which no catalyst material is deposited in order to provide more mechanical robustness. This other substrate sheet advantageously serves as a porous transport layer (PTL).

In an embodiment, the invention provides a stack comprising a catalyst sheet as described herein, having a thickness of 50 μm or less and comprising a first substrate sheet, stacked on a second substrate sheet, wherein the second substrate sheet is for instance a porous transport layer.

Because the catalyst material according to the invention is deposited on an electrically conductive substrate sheet, the use of electrically conductive binders such as ionomer binders is not necessary. Therefore, because binders can block access to the surface of the catalyst, thereby decreasing catalyst utilization, the catalyst sheet preferably comprises less than 5 wt. % binder relative to the total weight of the catalyst sheet, more preferably less than 1.0 wt. %. Most preferably, the catalyst sheet is substantially free of ionomer and/or other binders.

Because the porous substrate sheet as well as the catalyst material preferably comprise one or more metals, metal oxides, and/or, in case of the substrate sheet, metal carbides, -nitrides, and -borides, and because the presence of other materials such as binders may negatively affect catalyst utilization, the catalyst sheet preferably has a high content of metal and metal-based compounds. Preferably the catalyst sheet comprises 95 wt. % or more of one or more metals, metal alloys, and/or oxides, carbides, nitrides, and borides thereof, more preferably 97 wt. % or more, such as 99 wt. % or more.

The diameter of the pores of the substrate sheet can vary from 50 μm or less to as large as ca. 150 μm. In embodiments, the average diameter of the pores of the substrate sheet is 50 μm or less, preferably 0.5-15 μm, such as 1-10 μm. The smallest pores in the substrate sheet may have a pore diameter of less than 1 or even less than 0.5 μm, as long as the average pore diameter is not too small. However, if the average pore diameter is too small, problems with mass transport resistance may occur. The average pore diameter can for instance be measured using electron microscopy, such as Scanning Electron Microscopy (SEM).

In preferred embodiments, the substrate sheet may have a pore gradient and/or graded pores.

In particular in order to facilitate mass transfer towards and away from the catalyst material, a substrate sheet having a membrane side and an opposite side in a preferred embodiment exhibits a pore gradient and/or graded pores, the average pore diameter being smaller on the membrane side of the substrate sheet than on the opposite side of the substrate sheet.

Advantageously, such a substrate sheet with graded pores can be manufactured by providing a stack of multiple porous and electrically conductive sheets, wherein the porous and electrically conductive sheets on the membrane side of the stack have an average pore diameter that is smaller than the average pore diameter of the electrically conductive sheets on the opposite side of the stack.

In a specific embodiment, the substrate sheet comprises one or more selected from Ti, Zr, Hf, V, Nb, Ta, W, Cr, V, Mo, and oxides thereof, the average diameter of the pores of the substrate sheet is 50 μm or less, and the catalyst material comprises Ir and/or iridium oxide.

The surface area of the substrate sheet may be nanostructured resulting in a higher surface area onto which the catalyst material can be deposited. The nanostructuring may include height differences of 2 μm or less, such as 1 μm or less, and high regions with an average diameter of 20-100 nm. The nanostructuring may therefore provide for advantageous roughness of the substrate sheet. Preferably, the nanostructured surface area of the substrate sheet has a surface area enhancement of 5 times or more, more preferably 10 times or more, such as 5-100 times. A surface area enhancement of 5-100 times means that the nanostructured surface area of the substrate sheet is 5-100 times higher than the geometric area of the substrate sheet.

The nanostructuring can be achieved in various ways. One exemplary method of providing nanostructuring is etching the substrate sheet, e.g. Ti fiber cloth, using a strong basic solution, e.g. 5M NaOH, e.g. at 100-200° C., such as 140-180° C., for e.g. at least 30 min or at least 60 min. In experiments, this was found to result in hair-like whisker nanostructures with a length of about 1 μm, and in a very rough surface of the substrate, in particular for Ti fiber cloth as substrate.

In embodiments, the external and/or internal surface of the substrate sheet is covered at least partly, e.g. partly or entirely, with a coating layer onto which the catalyst material is deposited. The coating layer is preferably electrically conductive. The coating layer preferably comprises a material that influences the properties of the catalyst material deposited thereon through strong metal-support interaction. The coating material preferably comprises one or more selected from TIN, TiB₂, ZrC, and antimony-doped tin oxide. Such a coating can positively influence the catalyst activity or turnover frequency as well as durability.

Known ion-exchange membrane reactors typically have high loadings of expensive catalyst. Typical loadings of catalyst material on the anode side of a Proton Exchange Membrane Water Electrolyzer are e.g. 2 mg Ir/cm². With the catalyst sheet according to the invention, due to the improved catalyst utilization, it is possible to reach the desired performance at low catalyst loadings.

Preferably, the catalyst sheet has a catalyst material loading of 1000 μg/cm² or less, more preferably 500 μg/cm² or less. The catalyst sheet may even provide the desired activity with a catalyst material loading of 100 μg/cm² or even lower, for instance 50 μg/cm² or lower, or 20 μg/cm² or lower. For instance, the catalyst material loading can be as low as 1-100 μg/cm², or 5-20 μg/cm², or 1-10 μg/cm². It may even be possible to provide catalyst sheets that are active at catalyst material loadings of lower than 1.0 μg/cm², such as 0.1-1.0 μg/cm². The catalyst material loading described herein is expressed as catalyst weight per geometric area of the membrane, and can for instance be measured using inductively coupled plasma mass spectrometry (ICP-MS). As mentioned above, the catalyst material may comprise one or more selected from Ti, Zr, Hf, V, Nb, Ta, W, Cr, V, Mo, and oxides thereof. As used herein, in case the catalyst comprises a metal oxide or another metal compound (e.g. iridium oxide) the catalyst material loading refers to the amount of metal (e.g. iridium) per cm².

Preferably, the catalyst sheet is in direct contact with the membrane. Because the substrate sheet is electrically conductive, direct contact between the catalyst sheet and the membrane results in good electrical contact, and therefore efficient proton or anion transport from the deposited catalyst and the membrane, even when the deposited catalyst material itself is not in direct contact with the membrane. If, on the other hand, another layer, such as an adhesive, would be present between the catalyst sheet and the membrane, ion transport would be negatively influenced. Direct contact between the catalyst sheet and the membrane can for instance be achieved by hot-pressing the catalyst sheet onto the membrane.

Another aspect of the invention is a Proton Exchange Membrane Water Electrolyzer, comprising an anode, a cathode, a proton-exchange membrane, on each side of said proton-exchange membrane a catalyst layer and a porous transport layer and a bipolar plate, wherein at least one of the catalyst layers is provided as a catalyst sheet as described herein.

Analogously, there is also provided an Anion Exchange Membrane Water Electrolyzer, comprising an anode, a cathode, an anion-exchange membrane, on each side of said anion-exchange membrane a catalyst layer and a porous transport layer and a bipolar plate, wherein at least one of the catalyst layers is provided as a catalyst sheet as described herein.

Another term that can be used to denote a Proton Exchange Membrane Water Electrolyzer or an Anion Exchange Membrane Water Electrolyzer is Ion Exchange Membrane Water Electrolyzer.

The bipolar plate on each side of the ion exchange membrane is typically present in electrolyzers and helps in transporting reactants and products to and from the catalyst material.

The catalyst layers on opposite sides of the ion exchange membrane, respectively, may serve as anode or cathode in the electrolyzer.

All the preferences and detailed features discussion in connection with the catalyst sheet apply also for the Proton Exchange Membrane Water Electrolyzer and the Anion Exchange Membrane Water Electrolyzer. The catalyst sheet as used herein is

In cases where the catalyst sheet comprises a porous transport layer, a catalyst layer and an adjacent porous transport layer of the Proton Exchange Membrane Water Electrolyzer or Anion Exchange Membrane Water Electrolyzer as described herein may be provided together as one catalyst sheet according to the invention.

In a hydrogen production method according to the invention, hydrogen can be produced in a Proton Exchange Membrane Water Electrolyzer or Anion Exchange Membrane Water Electrolyzer as described herein, the method for producing hydrogen comprising providing water to the catalyst layer on each side of the ion-exchange membrane and applying a voltage between the anode and the cathode. The catalyst sheet as described herein, with all preferences and detailed features as described in the present disclosure, is preferably used for such a hydrogen production method.

FIG. 3 shows a schematic overview of a membrane electrode assembly according to an illustrative embodiment of the invention, in which membrane electrode assembly (1) comprises an ion-exchange membrane (2), on each side of membrane (2) a catalyst sheet (3), and a porous transport layer (4). Catalyst sheets (3) have membrane side (3a) and opposite side (3b). Adjacent to each porous transport layer (4), a bipolar plate (5) is typically provided, which helps with transporting reactants and products to and from the catalyst material.

It is also possible to provide a membrane electrode assembly having a catalyst sheet according to the invention on one side of the membrane, and a different type of catalyst layer on the other side of the membrane.

By using a catalyst sheet according to the invention, Proton Exchange Membrane Water Electrolyzers and/or Anion Exchange Membrane Water Electrolyzers can be obtained that can operate at high current densities, while using low catalyst material loadings. Preferably, electrolyzers according to the invention can operate at a current density of 0.5 A/cm² or more, preferably 0.8 A/cm² or more, more preferably, 1.0 A/cm² or more, such as 1.2 A/cm², or even 1.5 A/cm² or more. The current density that can be obtained may even be as high as 5.0 A/cm², such as 0.5-4.0 A/cm², or 0.8-3.0 A/cm², or 1-2.5 A/cm².

Preferably, these current densities are obtained using catalyst sheets with catalyst material loadings as specified above. In embodiments, the Proton Exchange Membrane Water Electrolyzer or Anion Exchange Membrane Water Electrolyzer can operate at a current density of 0.5 A/cm² or more using a catalyst material loading of 50 μg/cm² or lower. More preferably, the Proton Exchange Membrane Water Electrolyzer or Anion Exchange Membrane Water Electrolyzer can operate at a current density of 0.7 A/cm² or more using a catalyst material loading of 20 μg/cm² or lower, or even at 1.0 A/cm² or more using a catalyst material loading of 15 μg/cm² or lower, for instance at 1.0-3.0 A/cm² using a catalyst material loading of 5.0-15 μg/cm².

Another parameter that can be used to describe how efficiently the catalyst material is used is the specific power density of the catalyst sheet, which can for instance be defined as the weight of catalyst material that is needed for the electrolyzer to operate at a certain power. Preferably, the Proton Exchange Membrane Water Electrolyzer or Anion Exchange Membrane Water Electrolyzer has a specific power density of 0.010 grams of catalyst (g_{cat}) per kilowatt or lower, more preferably 0.008 g_{cat}/kW or lower, even more preferably 0.005 g_{cat}/kW or lower.

Also provided is a method of manufacturing a catalyst sheet, preferably a catalyst sheet as described herein, comprising:
producing and/or providing a porous and electrically conductive substrate sheet,
depositing a thin film or thin film patches of catalyst material on the internal and/or external surface of said substrate sheet. All preferences and detailed features discussed for the catalyst sheet apply also for the catalyst produced with the manufacturing method. The catalyst sheet is preferably used in a hydrogen production method as described herein and is preferably incorporated in a Proton Exchange Membrane Water Electrolyzer or Anion Exchange Membrane Water Electrolyzer as described herein.

Methods for depositing a thin film or thin film patches of catalyst material on the internal and/or external surface of said substrate sheet are known to the skilled person, and include wet chemical deposition methods, chemical vapor deposition, electrodeposition, atomic layer deposition, etc.

A deposition method which is particularly suitable for depositing the thin film or thin film patches of catalyst material is atomic layer deposition (ALD). Using ALD, very thin and well-defined layers with uniform thickness can be deposited.

ALD for example involves the spatial and/or temporal separate deposition of a metal-organic precursor and a co-reactant. In some embodiments of ALD, the precursor and co-reactant species are transported sequentially into a heated reaction zone containing the substrate sheet, resulting in two time-separated half-reaction steps.

ALD is for example used in embodiments wherein the substrate sheet is a metal fiber cloth, preferably wherein the substrate sheet comprises one or more selected from Ti, Zr, Hf, V, Nb, Ta, W, Cr, V, Mo, and oxides, borides, and carbides thereof, more preferably Ti fibers; and wherein the catalyst material is Ir or iridium oxide. In particular spatial ALD can be used.

Especially good results have been obtained using a special version of atomic layer deposition: spatial ALD (sALD). Other types of ALD may also be used.

An apparatus and method for spatial atomic layer deposition that can for example, but without restriction, be used is described in EP2159304A1, which is incorporated herein in its entirety. In spatial ALD, for example, the metal organic precursor and co-reactant species are transported simultaneously into spatially separated first and second heated reaction zones, with the substrate sheet moving from the first to the second deposition zone, resulting in two space-separated half-reaction steps. The first and second reaction zones are for instance spaced apart by shield zones where a gas shield is supplied.

The apparatus for spatial atomic layer deposition for instance comprises a precursor injector head, the precursor injector head comprising a precursor supply and a deposition space that in use is bounded by the precursor injector head and the substrate surface, wherein the precursor injector head is arranged for injecting a precursor gas from the precursor supply into the deposition space for contacting the substrate surface, wherein the apparatus is arranged for relative motion between the deposition space and the substrate in a plane of the substrate surface, and wherein the apparatus is provided with a confining structure arranged for confining the injected precursor gas to the deposition space adjacent to the substrate surface. For example, the precursor injector head comprises a gas injector for injecting a gas between the precursor injector head and the substrate surface and/or between the precursor injector head and a substrate holder that is mechanically attached to the substrate, the gas thus forming a gas-bearing layer.

For example the gas injector is formed by a bearing-gas injector, which is separate from the precursor supply, for creating the gas-bearing layer, and the precursor injector head is provided with projecting portions, wherein, in use, the gas-bearing layer is formed between the projecting portions and the substrate and/or between the projecting portions and a surface of the substrate holder, and forms a confining structure with which the apparatus is provided, for confining the injected precursor gas to the deposition space adjacent to the substrate surface.

Other types of apparatuses for spatial atomic layer deposition can also be used.

The method for spatial ALD is for example: a method for atomic layer deposition on a surface of a substrate using an apparatus including a precursor injector head, the precursor injector head comprising a precursor supply and a deposition space, wherein the deposition space in use is bounded by the precursor injector head and the substrate surface, the method comprising the steps of: a) injecting a precursor gas from the precursor supply into the deposition space for contacting the substrate surface; b) establishing relative motion between the deposition space and the substrate in a plane of the substrate surface; and c) confining the injected precursor gas to the deposition space adjacent to the substrate surface, to provide a deposition space that in use is bounded by the precursor injector head and the substrate surface. Preferably, the apparatus comprises a reaction space, and the method comprises the step of:

d) providing at least one of a reactant gas, a plasma, laser-generated radiation, and ultraviolet radiation, in the reaction space for reacting the precursor with the reactant gas after deposition of the precursor gas on at least part of the substrate surface in order to obtain the atomic layer on the at least part of the substrate surface.

Parameters that can be optimized in order to get the desired control over factors such as thickness and depth of deposition of the thin film or thin film patches include: dosage of the respective precursors, residence time, temperature, pre-processing of the surface, etc.

Optionally, using spatial atomic layer deposition, the penetration depth of catalyst deposition into the porous substrate sheet is fine-tunable.

Due to the movement of the substrate relative to the deposition space used in spatial atomic layer deposition, the penetration depth of the deposited thin film and/or thin film patches into the porous substrate can be reduced significantly compared to conventional atomic layer deposition techniques. Without wishing to be bound by way of theory, the relative movement of the substrate during deposition provides that precursor molecules are more likely to hit the internal surface of the substrate sheet, thereby preventing diffusion of the precursors deeper into the porous substrate sheet. This means that the diffusion depth into the substrate can be minimized and fine-tuned. The penetration depth can be fine-tuned inter alia by controlling the speed at which the substrate moves relatively to the deposition space, and by gas flow and pressure of the carrier gas. The desired speed and settings may depend for instance on the type of substrate, as well as on the porosity, pore size and tortuosity of the substrate.

When a larger fraction of the catalyst material is deposited close to the membrane side of the catalyst sheet, the catalyst material is more efficiently used due to more efficient proton or anion transport to and from the membrane, and therefore, good performance can be reached at lower loadings of catalyst material.

In the method as described herein, the preferred pore depth of depositing catalyst material is the same as described above for the catalyst sheet.

Also provided is a catalyst sheet as described herein, obtainable by the method as described herein.

In this description, the terms ‘typical’ and/or ‘typically’ are used to denote features that are often used, but that are not essential to the invention.

As described hereinabove, the invention pertains to a catalyst sheet, in particular for a Proton Exchange Membrane Water Electrolyzer or Anion Exchange Membrane Water Electrolyzer, comprising a substrate sheet and a deposited catalyst material, wherein the substrate sheet is porous and electrically conductive; and to an electrolyzer comprising such a catalyst sheet, a hydrogen production method, and a manufacturing method.

All preferences and features specified for the Proton Exchange Membrane Water Electrolyzer or Anion Exchange Membrane Water Electrolyzer, in particular in the claims, apply equally for the catalyst sheet as such.

### EXAMPLES

The invention will now be further illustrated by the following non-limiting examples. These examples do not limit the invention and do not limit the claims.

### Example 1

A catalyst sheet according to the invention was prepared by depositing ca. 5 nm thick patches of Iridium oxide onto a porous substrate sheet using spatial ALD. As Ir precursor, 1-ethylcyclopentadienyl-1,3-cyclohexadieneiridium (I), 99% (99.9%-Ir) was used. The porous substrate sheet was a 200 μm thick Bekipor® ST 2 GDL 10-0.25 cloth of Ti fibers having a diameter of ca. 22 μm, a porosity of 56%, and a weight of 500 g/m². The catalyst loading was measured using ICP-MS, and was ca. 11 μg Ir/cm².

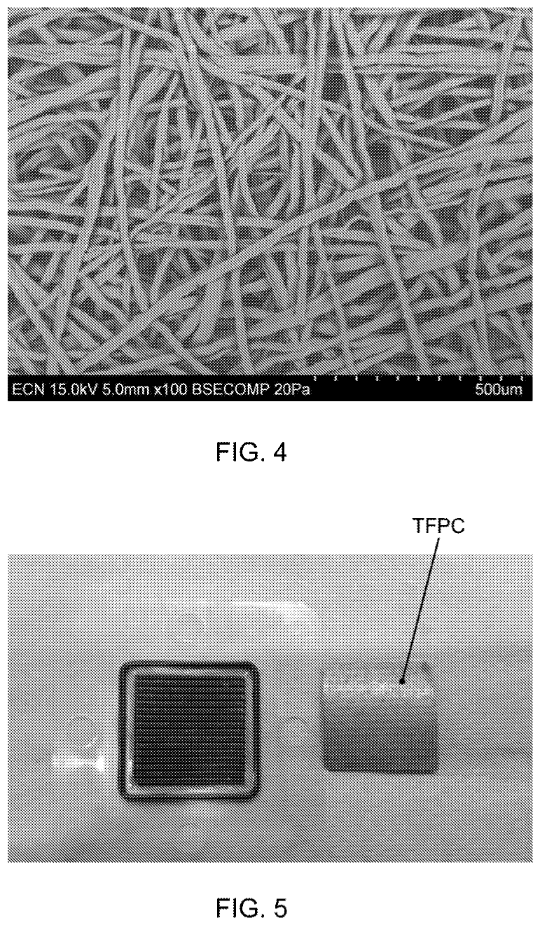

FIG. 4 shows an electron microscopy image of the substrate sheet used in Example 1.

FIG. 5 shows a photograph of the catalyst sheet prepared in Example 1, after the test of Example 2 (right) and (left) the transparent membrane through which the cathode catalyst layer can be seen. The parallel lines on the active area of the cathode are the impressions from flow fields that bring water to the catalyst layer, and take bubbles away from the catalyst layer.

### Example 2

A membrane electrode assembly comprising on the anode side the catalyst sheet prepared in example 1 was used for the electrolysis of water. The membrane was Nafion™ 115 with a thickness of 127 μm. The cathode electrode was a commercially available gas diffusion electrode with Pt nanoparticles supported on Vulcan carbon with a loading of 0.5 mg/cm², obtained from FuelCellsEtc, Texas (product no. W1S1010).

The performance was compared to a reference membrane electrode assembly, in which the anode catalyst layer was Ir black (Alfa Aesar) 2±0.1 mg Ir/cm², and 23 wt. % Nafion™ 1100.

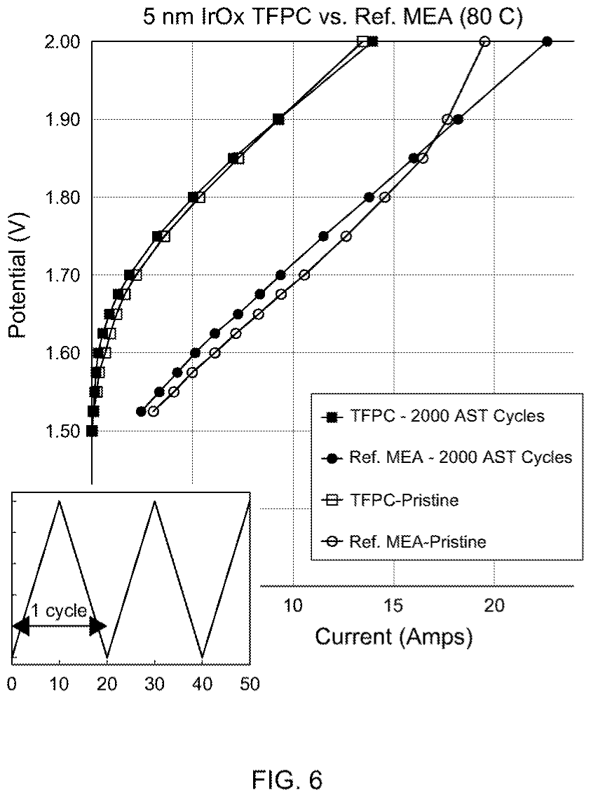

FIG. 6 shows that the pristine catalyst sheet prepared in example 1 (TFPC) shows very good performance compared to the membrane electrode assembly with the reference catalyst layer, especially considering that the catalyst loading of the catalyst sheet of example 1 is almost 200 times lower than the catalyst loading of the reference catalyst layer.

The membrane electrode assembly comprising the thin film porous catalyst layer prepared in example 1 and the reference membrane electrode assembly were tested in an accelerated stress test of 2000 cycles of increasing and decreasing potential, which cycles are shown in the bottom left of FIG. 6. It can be seen from FIG. 6 that the assembly with the thin film porous catalyst layer of example 1 hardly shows any degradation after 2000 cycles, whereas the reference assembly shows significant degradation.

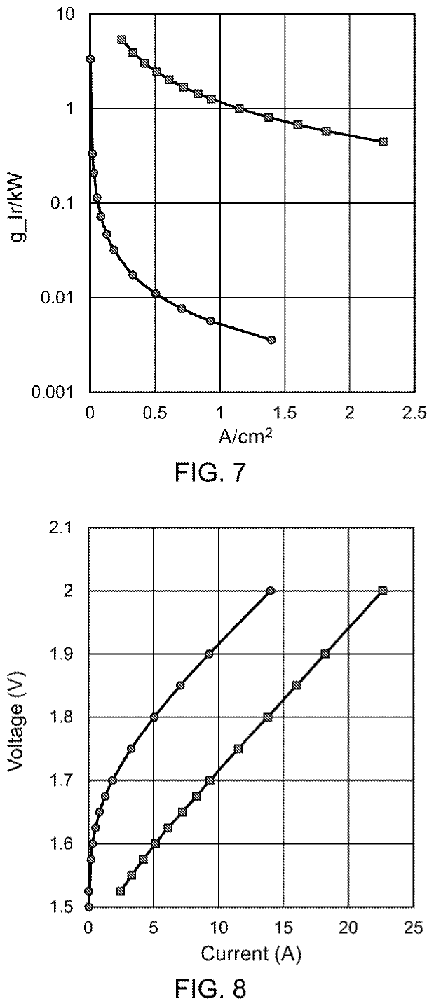

FIG. 7 shows a plot of the specific power density at different current densities, for a membrane electrode assembly (MEA) with the inventive catalyst sheet of example 1 (circles) and a reference MEA (squares), both after the accelerated stress test of 2000 cycles. The reference MEA operates with 2 mg-Ir/cm² based on nanoparticles (Ir-black) with surface area enhancement factor (SEF) of 400-600/cm². The inventive catalyst sheet operates at 0.01 mg-Ir/cm² (i.e. 200 times lower catalyst loading than the reference MEA) and SEF of about 0.5 or even less. It can be seen that using the membrane electrode assembly made according to example 1, it is possible to reach high current densities at much lower specific power density (lower value in g_{cat}/kW) compared to the reference electrode, even values <0.01 g_{cat}/kW are achieved with the inventive MEA thereby exceeding the target.

FIG. 8 shows the IV (polarization) curve for the same samples as in FIG. 7 (inventive: circles; reference: squares); both with 10 cm² active area.

### Example 3

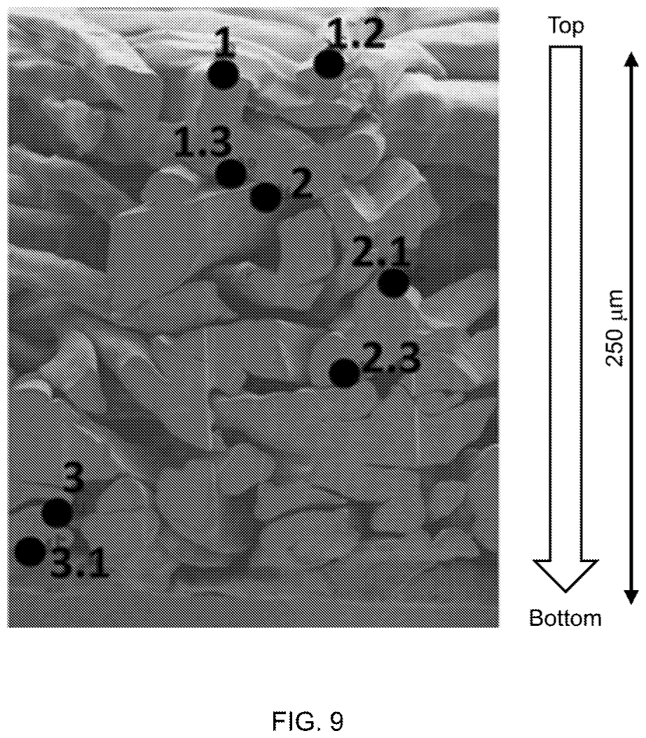

The Ir distribution through a catalyst sheet according to the invention was studied using high resolution SEM and EDX. A thick IrOₓ layer (30 nm) was deposited using sALD on top of a commercial metal cloth substrate of 250 μm thickness (Bekipor®). A large thickness of the IrO₂ layer was used for detectability of the Ir. FIG. 9 shows a cross-sectional SEM image.

Ir containing layers of 26 and 28 nm thick were observed in a high resolution magnification of the dots in FIG. 9, positions 1 and 1.2; Ir containing layers of 9 and 13 nm thick at intermediate thickness (positions 2.1 and 1.3) and no Ir containing layers were observed spots at greater depths (positions 3, 3.1. and 2.3).

1. A catalyst sheet comprising a substrate sheet and a deposited catalyst material, wherein the substrate sheet is porous and electrically conductive, and wherein the catalyst material is deposited as a thin film or as thin film patches on the internal surface, the external surface, or both the internal surface and the external surface of said substrate sheet.

2. The catalyst sheet of claim 1, wherein the mean thickness of the thin film, the thin film patches, or both the thin film and the thin film patches is 5 nm or less, measured using transmission electron microscopy.

3. The catalyst sheet of claim 1, having a catalyst material loading of 100 μg/cm² or less.

4. The catalyst sheet of claim 1, wherein more than 50 wt. % of the deposited catalyst material is deposited on the internal surface of the substrate at a pore depth of 50 μm or less.

5. The catalyst sheet of claim 1, wherein 80 wt. % or more of the total amount of catalyst material is deposited on the internal surface of the substrate sheet at a pore depth of 0.10 μm-20 μm.

6. The catalyst sheet of claim 1, wherein the substrate consists of metal fiber cloth, and wherein the catalyst material comprises iridium, iridium oxide, or both iridium and iridium oxide.

7. A membrane electrode assembly for an electrochemical reactor comprising an ion-exchange membrane and an adjacent catalyst layer, wherein the catalyst layer is provided as a catalyst sheet of claim 1.

8. The membrane electrode assembly of claim 7, wherein the catalyst sheet comprises a catalyst layer and a porous transport layer.

9. The membrane electrode assembly of claim 7, wherein the catalyst sheet is in direct contact with the ion-exchange membrane.

10. A Proton Exchange Membrane Water Electrolyzer or Anion Exchange Membrane Water Electrolyzer, comprising an anode, a cathode, a proton-exchange membrane or an anion-exchange membrane, on each side of said proton-exchange membrane or anion-exchange membrane a catalyst layer and a porous transport layer and a bipolar plate, wherein at least one of the catalyst layers is a catalyst sheet of claim 1 comprising said substrate sheet and said deposited catalyst material.

11. The Proton Exchange Membrane Water Electrolyzer or Anion Exchange Membrane Water Electrolyzer of claim 10, wherein the substrate sheet comprises one or more selected from Ti, Zr, Hf, V, Nb, Ta, W, Cr, V, Mo, and oxides, borides, and carbides thereof.

12. The Proton Exchange Membrane Water Electrolyzer or Anion Exchange Membrane Water Electrolyzer of claim 10, wherein the catalyst material comprises iridium, iridium oxide, or both iridium and iridium oxide.

13. The Proton Exchange Membrane Water Electrolyzer or Anion Exchange Membrane Water Electrolyzer of claim 10, wherein the thin film or thin film patches each have a length direction and a width direction, which extend along the surface of the substrate sheet and are perpendicular to each other, and a thickness direction perpendicular to both the length direction and width direction, wherein the length and width of the thin film or thin film patches are, independently of each other, at least 2 times higher than the thickness of the thin film or thin film patches.

14. The Proton Exchange Membrane Water Electrolyzer or Anion Exchange Membrane Water Electrolyzer of claim 10, wherein the thin film or thin film patches each have a thickness of 5 nm or less measured using transmission electron microscopy.

15. The Proton Exchange Membrane Water Electrolyzer or Anion Exchange Membrane Water Electrolyzer of claim 10, wherein the majority of the catalyst material is deposited on the internal surface of the substrate sheet at a pore depth >0.10 μm.

16. The Proton Exchange Membrane Water Electrolyzer or Anion Exchange Membrane Water Electrolyzer of claim 10, wherein 80 wt. % or more of the total amount of catalyst material is deposited on the internal surface of the substrate sheet at a pore depth of 0.10 μm-20 μm.

17. The Proton Exchange Membrane Water Electrolyzer or Anion Exchange Membrane Water Electrolyzer of claim 10, wherein the catalyst sheet comprises less than 5 wt. % ionomer relative to the total weight of the catalyst sheet.

18. The Proton Exchange Membrane Water Electrolyzer or Anion Exchange Membrane Water Electrolyzer of claim 10, wherein the wt. % relative to the total weight of the catalyst sheet comprises 95 wt. % or more of metal, metal alloy, metal oxide, or one or more combinations thereof.

19. The Proton Exchange Membrane Water Electrolyzer or Anion Exchange Membrane Water Electrolyzer of claim 10, wherein the average diameter of the pores of the substrate sheet is 150 μm or less.

20. The Proton Exchange Membrane Water Electrolyzer or Anion Exchange Membrane Water Electrolyzer of claim 10, wherein the substrate sheet has a membrane side and an opposite side, and wherein the substrate sheet has a pore gradient, graded pores, or both a pore gradient and graded pores, the average pore diameter being smaller on the membrane side of the substrate sheet than on the opposite side of the substrate sheet.

21. The Proton Exchange Membrane Water Electrolyzer or Anion Exchange Membrane Water Electrolyzer of claim 10, wherein the substrate sheet comprises a stack of multiple porous and electrically conductive sheets.

22. The Proton Exchange Membrane Water Electrolyzer or Anion Exchange Membrane Water Electrolyzer of claim 10, wherein the substrate sheet comprises one or more selected from Ti, Zr, Hf, V, Nb, Ta, W, Cr, V, Mo, and oxides, nitrides, borides, and carbides thereof, wherein the average diameter of the pores of the substrate sheet is 50 μm or less, and wherein the catalyst material comprises Ir, iridium oxide, or both Ir and iridium oxide.

23. The Proton Exchange Membrane Water Electrolyzer or Anion Exchange Membrane Water Electrolyzer of claim 10, wherein the surface area of the substrate sheet is nanostructured, rough, or both nanostructured and rough.

24. The Proton Exchange Membrane Water Electrolyzer or Anion Exchange Membrane Water Electrolyzer of claim 10, wherein the external surface, the internal surface, or both the external surface and the internal surface of the substrate sheet is covered at least partly with a conductive coating layer onto which the catalyst material is deposited.

25. The Proton Exchange Membrane Water Electrolyzer or Anion Exchange Membrane Water Electrolyzer of claim 10, wherein the catalyst sheet has a catalyst material loading of 1 mg/cm² or lower.

26. The Proton Exchange Membrane Water Electrolyzer or Anion Exchange Membrane Water Electrolyzer of claim 10, wherein a catalyst layer and an adjacent porous transport layer are together provided as one catalyst sheet comprising a substrate sheet and a deposited catalyst material, wherein the substrate sheet is porous and electrically conductive, and wherein the catalyst material is deposited as a thin film or as thin film patches on the internal surface, the external surface, or both the internal and external surface of said substrate sheet.

27. A hydrogen production method carried out in a Proton Exchange Membrane Water Electrolyzer or Anion Exchange Membrane Water Electrolyzer of claim 10, comprising providing water to the catalyst layer on each side of the proton-exchange membrane and applying a voltage between the anode and the cathode.

28. A method of manufacturing a catalyst sheet of claim 1, the method comprising:
producing or providing a porous and electrically conductive substrate sheet; and
depositing a thin film or thin film patches of catalyst material on the internal surface, the external surface, or both the internal surface and the external surface of said substrate sheet.

29. The method of manufacturing a catalyst sheet of claim 28, wherein the thin film or thin film patches of catalyst material are deposited by atomic layer deposition.

30. The method of claim 28, wherein the substrate sheet is a metal fiber cloth.

31. The method of claim 29, wherein the atomic layer deposition comprises spatial atomic layer deposition.

32. The method of claim 29, wherein the spatial atomic layer deposition is performed in an apparatus comprising a precursor injector head, the precursor injector head comprising a precursor supply and a deposition space that in use is bounded by the precursor injector head and the substrate surface, wherein the precursor injector head is arranged for injecting a precursor gas from the precursor supply into the deposition space for contacting the substrate surface, wherein the apparatus is arranged for relative motion between the deposition space and the substrate in a plane of the substrate surface, and wherein the apparatus is provided with a confining structure arranged for confining the injected precursor gas to the deposition space adjacent to the substrate surface.

33. A catalyst sheet of claim 1, produced by a method of producing or providing a porous and electrically conductive substrate sheet; and
depositing a thin film or thin film patches of catalyst material on the internal surface, the external surface, or both the internal and external surface of said substrate sheet.
